(19) United States
(12) Patent Application Publication
(10) Pub. No.: US 2009/0207088 A1
(43) Pub. Date: Aug. 20, 2009

(54) ANTENNA APPARATUS

(75) Inventors: Sho SATO, Tokyo (JP); Hisamatsu Nakano, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co., Ltd., Tokyo (JP)

(21) Appl. No.: 12/370,799

(22) Filed: Feb. 13, 2009

(30) Foreign Application Priority Data
Feb. 18, 2008 (JP) 2008-036210

(51) Int. Cl. H01Q 19/13

(52) U.S. Cl. 343/818

(57) ABSTRACT

An antenna apparatus, including: an antenna device including a feeding point and a pair of antenna elements placed symmetrically with respect to the feeding point; and a parasitic device placed parallel to each of the antenna elements of the antenna device and including one or a plurality of elements placed at a position separated from each of the antenna elements, wherein the element of the parasitic device includes a gap at a center of the element in an extending direction and includes a pair of sub-elements structured symmetrically with respect to the gap as a boundary.

### BACKGROUND OF THE INVENTION

1. Field of the Invention

The present invention relates to an antenna apparatus, and in particular, an antenna apparatus including a dipole antenna and a parasitic device.

2. Description of Related Art

A Yagi-Uda Antenna is known as an antenna apparatus for sending and receiving television broadcasting, etc. Typically, the Yagi-Uda Antenna is configured by combining a dipole antenna which is a fed radiator, and a parasitic director and reflector provided parallel to the dipole antenna. As shown in FIG. 10, an antenna apparatus 100 combining only a dipole antenna DA and parasitic device E is also broadly called a Yagi-Uda Antenna.

As for the antenna apparatus 100 shown in FIG. 10, in order to reduce a size for a purpose such as for setting indoors, an object of consideration is use of the parasitic device E as a director where a distance d between the dipole antenna DA and the parasitic device E requires only a quarter wavelength.

However, in order to send and receive radio waves in a UHF band (470 to 770 MHz) of terrestrial digital broadcasting using the antenna apparatus 100, the distance d between the dipole antenna DA and the parasitic device E can be a quarter wavelength, however, the distance needs to be at least about 100 mm to 150 mm.

Therefore, it is difficult to achieve a thinner antenna apparatus, at least by shortening the distance between the dipole antenna DA and the parasitic device E, and there is a problem that the antenna apparatus 100 becomes larger for a purpose such as setting indoors. With the Yagi-Uda Antenna-type antenna apparatus 100, due to its principle, the distance d cannot be made shorter than as described above, therefore, the above-described problem cannot be solved.

In order to solve the above problem, Japanese Patent Application Laid-Open Publication No. 2007-235460 (hereinafter referred to as Patent Document 1) proposes an antenna apparatus using an antenna as a radiator where the antenna is supported at a center section of an Electromagnetic Band Gap (EBG) plate and a periodic structure upper plate is provided parallel to the EBG plate at a position separated a predetermined distance from a principal surface of the EBG plate. This antenna apparatus can send and receive radio waves effectively even when the distance between a curl antenna and the periodic structure upper plate is shorter than the above-described quarter wavelength.

Incidentally, a structure of an antenna apparatus is possible where the structure of the antenna apparatus described in Patent Document 1 is applied to the dipole antenna DA shown in FIG. 10, and instead of the curl antenna, the dipole antenna DA is supported at the center section of the EBG plate and the periodic structure upper plate is provided above the EBG plate.

However, in this case, when the dipole antenna DA is, for example, about 200 mm to 300 mm in total length in a longitudinal direction, in order to send and receive radio waves in a UHF band of terrestrial digital broadcasting as described above, the EBG plate and the periodic structure upper plate need to be formed in an almost square shape with a length of each side being about the same as the above-described length or longer.

As described above, by applying the structure of the antenna apparatus described in the Patent Document 1 to the dipole antenna DA, the distance between the periodic structure upper plate as the parasitic device and the antenna can be shortened in the sending and receiving direction of the radio waves of the antenna and the antenna apparatus can be made thinner, however, in a perpendicular direction to the sending and receiving direction of the radio waves, the structure of the antenna apparatus needs to have a large area, therefore, the antenna apparatus cannot be made smaller.

Although not limited to an antenna apparatus for sending and receiving terrestrial digital broadcasting, there is a demand especially for an antenna apparatus for sending and receiving terrestrial digital broadcasting to be able to be provided inside a home, and there is a demand for the antenna apparatus to be thinner and smaller. Also, as a characteristic of the dipole antenna, a sending and receiving sensitivity of a certain frequency range depending on its length in the longitudinal direction becomes high, and the frequency band of the UHF band (470 MHz to 770 MHz) of the terrestrial digital broadcasting is relatively wide, therefore, there is a demand for the antenna apparatus to have a broader band of sending and receiving sensitivity.

### SUMMARY OF THE INVENTION

It is, therefore, a main object of the present invention to provide an antenna apparatus which can be smaller and thinner, and also have a broader band of sending and receiving sensitivity.

According to an aspect of the present invention, there is provided an antenna apparatus, comprising:

an antenna device including a feeding point and a pair of antenna elements placed symmetrically with respect to the feeding point; and

a parasitic device placed parallel to each of the antenna elements of the antenna device and including one or a plurality of elements placed at a position separated from each of the antenna elements, wherein

the element of the parasitic device includes a gap at a center of the element in an extending direction and includes a pair of sub-elements structured symmetrically with respect to the gap as a boundary.

### BRIEF DESCRIPTION OF THE DRAWINGS

The above and other objects, advantages, and features of the present invention will become more fully understood from the detailed description given hereinbelow and the appended drawings which are given by way of illustration only, and thus are not intended as a definition of the limits of the present invention, wherein:

FIG. 1 is a perspective view showing a structure of an antenna apparatus of the embodiment;

FIG. 2 is a plan view showing the antenna apparatus shown in FIG. 1;

FIG. 3A is a plan view showing an antenna apparatus with one element;

FIG. 3B is a plan view showing an antenna apparatus with six elements;

FIG. 4 is a graph showing a gain of the antenna apparatus of the present invention and the Yagi-Uda antenna-type antenna apparatus;

FIG. 5A is a diagram explaining a direction of an image electric current generated in a parasitic device of the Yagi-Uda antenna-type antenna apparatus;

FIG. 5B is a diagram explaining a direction of an image electric current generated in a parasitic device of the antenna apparatus of the present embodiment;

FIG. 6 is a graph showing a relation between frequency and return loss when a number of elements (number of pairs of sub-elements) is changed in the antenna apparatus of the present embodiment;

FIG. 7 is a diagram showing a side view of the antenna apparatus shown in FIG. 1;

FIG. 8 is a perspective view showing a modification of the antenna device composed of a meander antenna;

FIG. 9 is a perspective view showing a modification of the antenna device composed of a bow-tie antenna; and

FIG. 10 is a diagram showing a Yagi-Uda antenna combining a dipole antenna and parasitic device.

### DESCRIPTION OF THE PREFERRED EMBODIMENTS

The best mode for carrying out the antenna apparatus according to the present invention will be explained in detail with reference to the drawings. However, the scope of the invention is not limited by the illustrated examples.

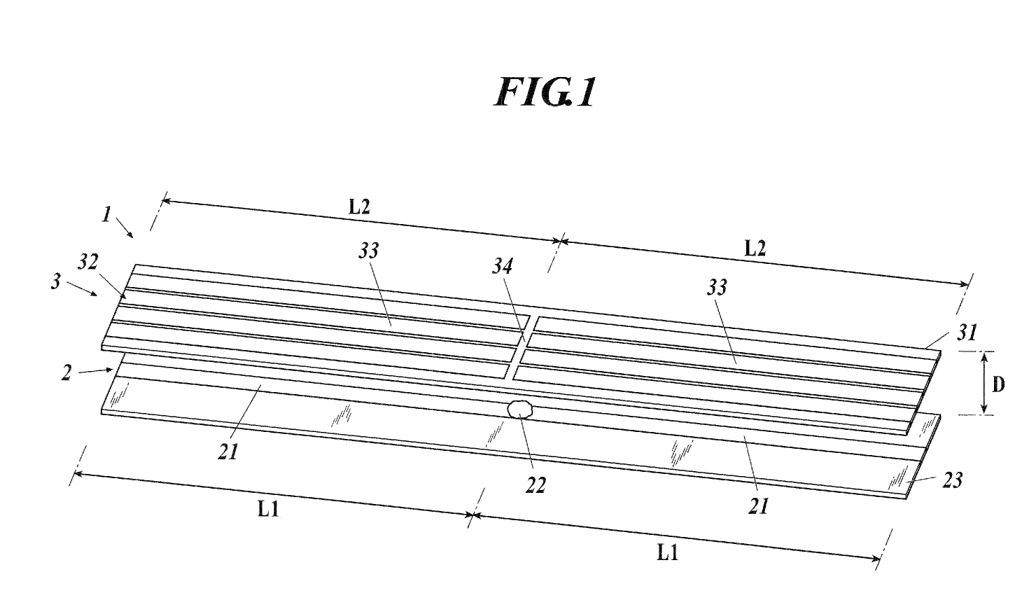

As shown in FIG. 1, the antenna apparatus 1 of the present invention includes an antenna device 2 and a parasitic device 3. In the embodiment below, an example where the antenna device 2 is composed of a dipole antenna is explained.

The antenna device 2 includes a pair of antenna elements 21 and 21 placed symmetrically on a straight line and includes a feeding point 22 at a portion connecting the pair of antenna elements 21 and 21, in other words, at a center portion in an extending direction of the pair of antenna elements 21 and 21. Length L1 of each of the antenna elements 21 is set for example, in a length of a quarter wavelength of a wavelength corresponding to a predetermined frequency within a UHF band (470 to 770 MHz) of terrestrial digital broadcasting which the antenna device 2 is to send and receive.

In the present embodiment, the antenna device 2 is a strip of metal where a length in a direction orthogonal to the extending direction of each of the antenna elements 21, in other words, a width is 10 mm, however, including the width, a specific structure is not required, and a normal typical dipole antenna is used. Needless to say, the structure, etc. of the dipole antenna composing the antenna device 2 is suitably designed to be suitable for a purpose required in the antenna apparatus 1 such as sending and receiving terrestrial digital broadcasting.

In the present embodiment, the parasitic device 3 is composed including four elements 32 in the antenna apparatus 1 shown in FIG. 1 on a flat plate shaped insulated substrate 31 placed at a parallel position separated a predetermined distance D from an insulated substrate 23 where the antenna device 2 is formed. Each of the elements 32 is placed parallel to the extending direction of each of the antenna elements 21 of the antenna device 2.

Each of the elements 32 of the parasitic device 3 is composed including a pair of sub-elements 33 each placed on a straight line. In other words, each of the elements 32 includes a gap 34 at a center in the extending direction and the pair of sub-elements 33 is to be symmetrical with respect to the gap 34 as a boundary.

The length L2 of each of the sub-elements 33 are all formed with a same length. The length L2 of each of the sub-elements 33 is formed with the same length as the length L1 of each of the antenna elements 21 of the antenna device 2 and the length L2 is suitably adjusted so that the sending and receiving sensitivity of the antenna device 2 is most suitable. In the present embodiment, each of the sub-elements 33 is provided by applying copper foil on the insulated substrate 31.

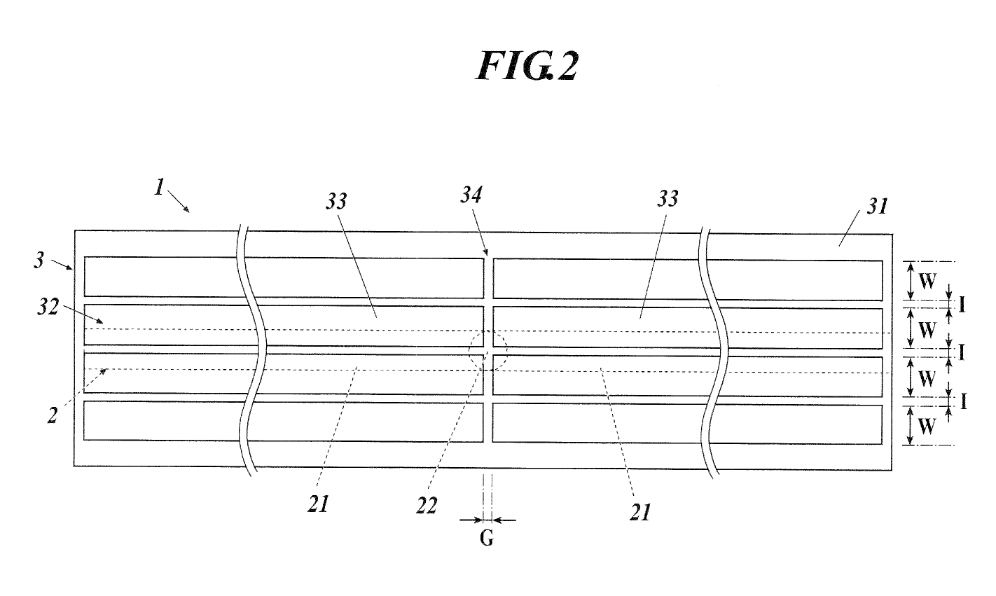

As shown in the perspective view shown in FIG. 1 and the plan view shown in FIG. 2, the gap 34 of each of the elements 32 of the parasitic device 3 is provided above the feeding point 22 of the antenna device 2, or to be accurate, a position separated a predetermined distance D from the feeding point 22 in a direction orthogonal to the extending direction of the antenna elements 21 and 21.

As shown in FIG. 2, each of the elements 32 of the parasitic device 3 is aligned parallel at a predetermined interval I in a direction orthogonal to the extending direction. Also, each of the elements 32 is formed so that a length in a direction orthogonal to the extending direction, in other words, width W, the width G of the gap 34 and the interval I between each of the elements 32 are each the same.

Including when the length L2 of each of the sub-elements 33 as described above is the same, when the width W, etc. of each of the elements 32 is the same, error within the margin of manufacturing error, etc. is obviously allowed. Also, the width W of each of the elements 32 of the parasitic device 3 and the interval I between the elements 32 do not need to be the same, and a structure where the widths W of the elements 32 are different from one another or the intervals I between the elements 32 are different from one another is possible.

In the present embodiment, since the width of each of the antenna elements 21 of the antenna device 2 is formed at 10 mm as described above, each of the elements 32 of the parasitic device 3 is formed so that the width W of each of the sub-elements 33 is 10 mm and the interval I between the sub-elements 33 is about 1 to 2 mm.

However, the shapes of the width W and the interval I of each of the elements 32 (each of the sub-elements 33) of the parasitic device 3 are not limited to the above described shape and the shape shown in FIG. 1 or FIG. 2, and is suitably determined so that, for example, the sending and receiving sensitivity of the UHF band (470 to 770 MHz) of terrestrial digital broadcasting is enhanced. Also, since it is known that impedance can be adjusted by adjusting a width G of the gap 34 which is provided at a center of each of the elements 32 of the parasitic device 3 in the extending direction and which is the border of the pair of the sub-elements 33 and 33, the width G of the gap 34 is suitably adjusted in order to obtain a suitable impedance.

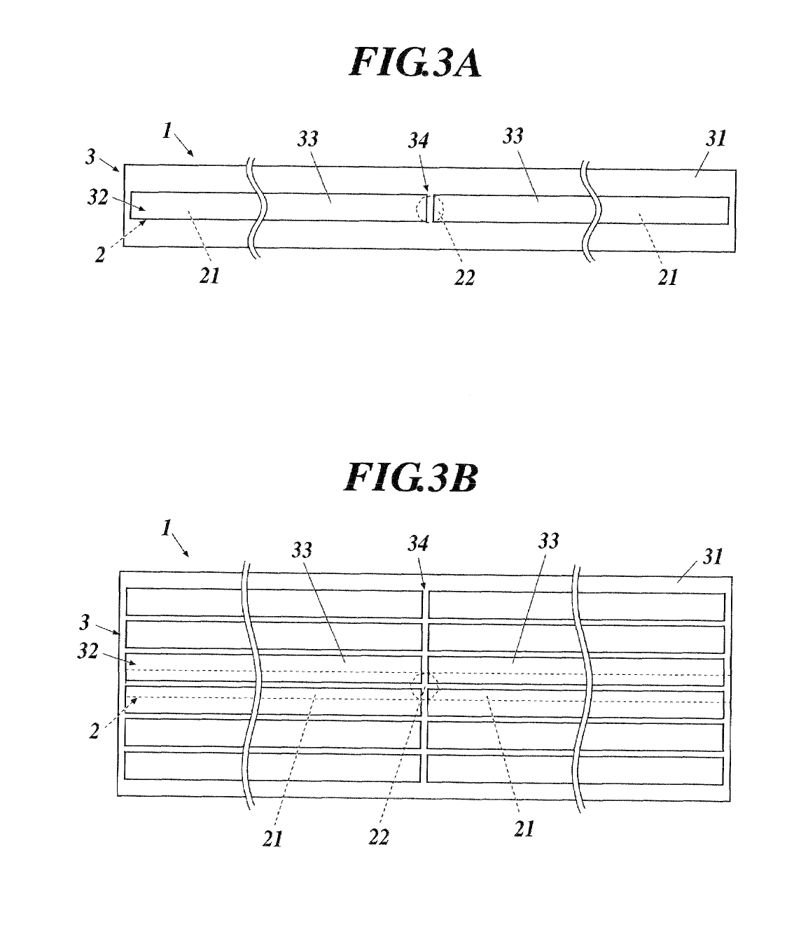

The antenna apparatus 1 shown in FIG. 1 and FIG. 2 shows an example where the parasitic device 3 includes four elements 32 (four pairs of sub-elements 33 and 33), however, as shown in the plan view shown in FIG. 3A and FIG. 3B, the parasitic device 3 can be structured to include one element 32 (one pair of sub-elements 33 and 33) (see FIG. 3A) or six elements 32 (six pairs of sub-elements 33 and 33) on the flat plate shaped insulated substrate 31 and the number of elements (pairs of sub-elements) is not limited to a specific number and the number is suitably determined according to the above described width W, interval I, etc. of the element.

Next, an operation of the antenna apparatus 1 of the present embodiment is described.

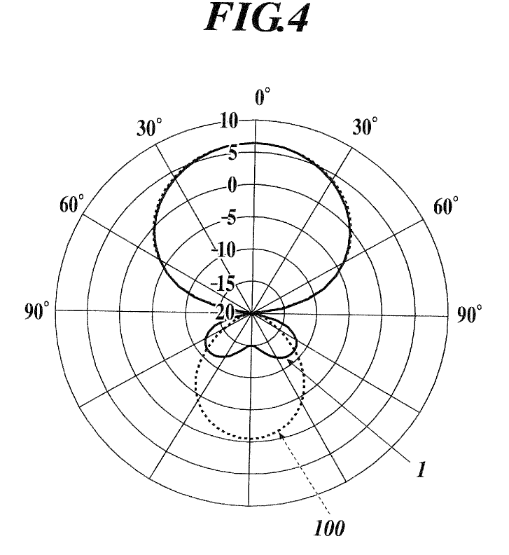

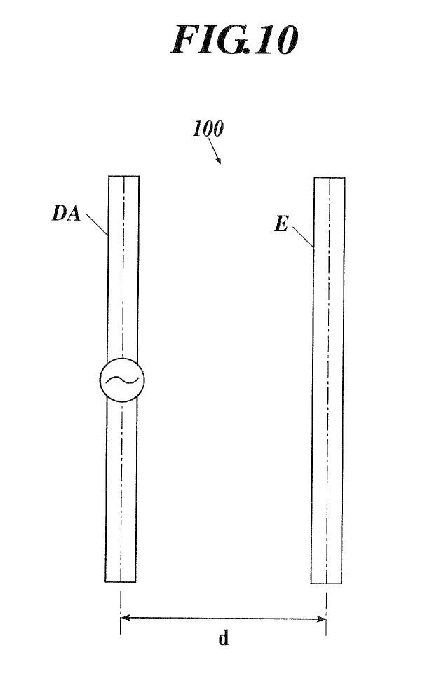

First, comparing the quality of the sending and receiving sensitivity of the antenna apparatus 1 of the present embodiment as shown in FIG. 1 to FIG. 3 and the Yagi-Uda antenna-type antenna apparatus 100 of a type with a combination of dipole antenna and parasitic device as shown in FIG. 10, as for front face of the apparatus, in other words, the direction from the dipole antenna to the parasitic device, as shown in FIG. 4, almost the same gain can be obtained between the antenna apparatus 1 (solid line in figure) and the antenna apparatus 100 (broken line in figure).

In this case, as for the Yagi-Uda antenna-type antenna apparatus 100, the distance d between the dipole antenna DA and the parasitic device E is a quarter wavelength (in other words, in this case, the parasitic device E is used as a director), and as for the antenna apparatus 1 of the present embodiment, the width W of the element 32 (sub-element 33) of the parasitic device 3 is the same as the width of the antenna element 21 of the antenna device 2 which is a dipole antenna and six elements 32 are provided (six pairs of sub-elements 33). The distance D between the antenna device 2 and the parasitic device 3 is set at one-tenth wavelength.

As described above, as for the antenna apparatus 1 of the present embodiment, even when the distance D between the antenna device 2 and the parasitic device 3 is one-tenth wavelength (about 40 mm to 60 mm), which is shorter than the distance d (a quarter wavelength, about 100 mm to 150 mm) between the dipole antenna DA and the parasitic device E in the Yagi-Uda antenna-type antenna apparatus 100, at least as for the front face of the apparatus, the same quality as the Yagi-Uda antenna-type antenna apparatus 100 can be obtained.

In the antenna apparatus 1 of the present embodiment, when the number of the element 32 is a number other than six (the number of pairs of sub-elements 33 is a number other than six pairs), in other words, for example, when the number is changed to one, two or four, at least as for the front face of the apparatus, an experimental result has been obtained showing that the same gain as the Yagi-Uda antenna-type antenna apparatus 100 can be obtained.

The reason why the distance D between the antenna device 2 which is the dipole antenna and the parasitic device 3 can be made shorter as described above in the antenna apparatus 1 of the present embodiment than in the Yagi-Uda antenna-type antenna apparatus 100 is thought to be as follows.

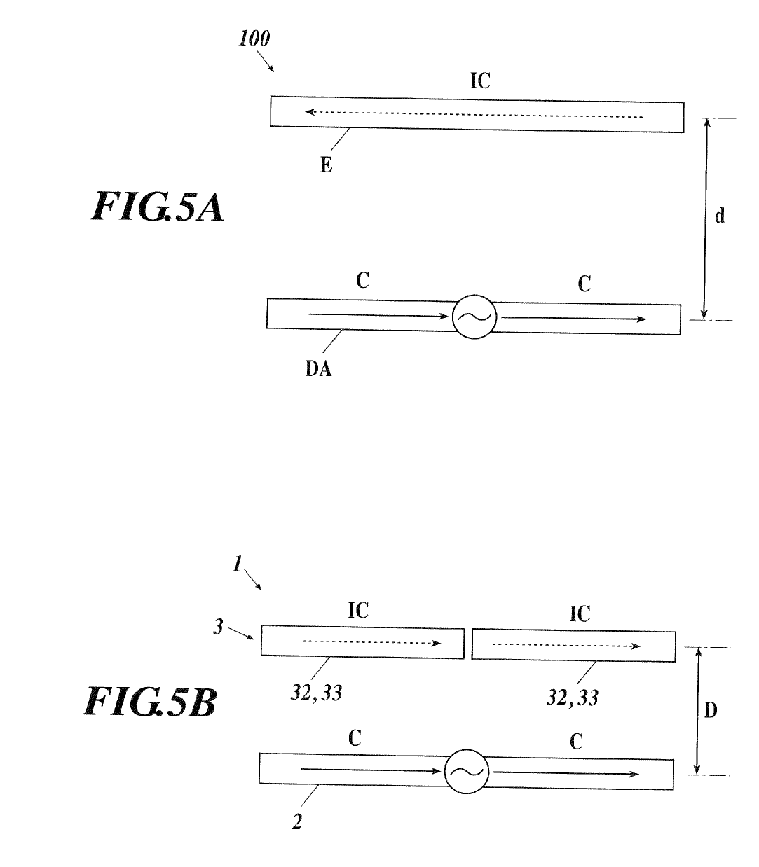

In other words, it is known that as shown in FIG. 5, when a unidirectional electric current C is generated in the dipole antenna when the dipole antenna sends and receives radio waves, in the Yagi-Uda antenna-type antenna apparatus 100 (see FIG. 5A), an image electric current IC in an opposite direction of the electric current C generated in the dipole antenna DA is generated in the parasitic device E, whereas in the antenna apparatus 1 of the present embodiment (see FIG. 5B), by providing a gap 34 in each of the elements 32 of the parasitic device 3 and dividing each of the elements 32 to a pair of sub-elements 33, an image electric current IC in the same direction as the electric current C generated in the antenna device 2 is generated in the pair of sub-elements 33 of each of the elements 32 of the parasitic device 3.

Since the image electric currents IC are generated in the parasitic devices in the directions shown in FIG. 5A and FIG. 5B, in the Yagi-Uda antenna-type antenna apparatus 100 shown in FIG. 5A, when the parasitic device E is brought close to the dipole antenna DA, the image electric current IC generated in the parasitic device E cancels out the electric current C generated in the dipole antenna DA. Therefore, the parasitic device E cannot be brought closer to the dipole antenna DA so as to be a distance d shorter than the quarter wavelength.

On the other hand, in the antenna apparatus 1 of the present embodiment shown in FIG. 5B, the direction of the image electric current IC generated in the pair of sub-elements 33 of each of the elements 32 of the parasitic device 3 is the same direction as the electric current C generated in the antenna device 2, therefore, even when the distance D is made closer so as to be a distance shorter than the quarter wavelength, the currents do not cancel each other out as in the case of the Yagi-Uda antenna-type antenna apparatus 100.

Therefore, it is considered in the antenna apparatus 1 of the present embodiment, the distance D between the antenna device 2 and the parasitic device 3 can be made shorter than the quarter wavelength, and the distance can be made close up to, for example, one-tenth wavelength.

Alternatively, an experiment was performed to see how the sending and receiving sensitivity of the antenna apparatus 1 to a frequency of a radio wave changes when the number of elements 32 (number of pairs of sub-elements 33) changes in the antenna apparatus 1 of the present embodiment.

In the experiment, the length L1 of each of the antenna elements 21 of the antenna device 2 is set so that a radio wave for example, of about 490 MHz can be sent and received, and the length L2 of each of the sub-elements 33 of each of the elements 32 of the parasitic device 3 is set to a suitable length similar to the length L1. Also, the distance D between the antenna device 2 and the parasitic device 3 is one-tenth wavelength, and the number of elements 32 (number of pairs of the sub-elements 33) of the parasitic device 3 was changed such as one (one pair), two (two pairs), four (four pairs) and six (six pairs). The experiment was performed by a method of measuring return loss in a dB unit.

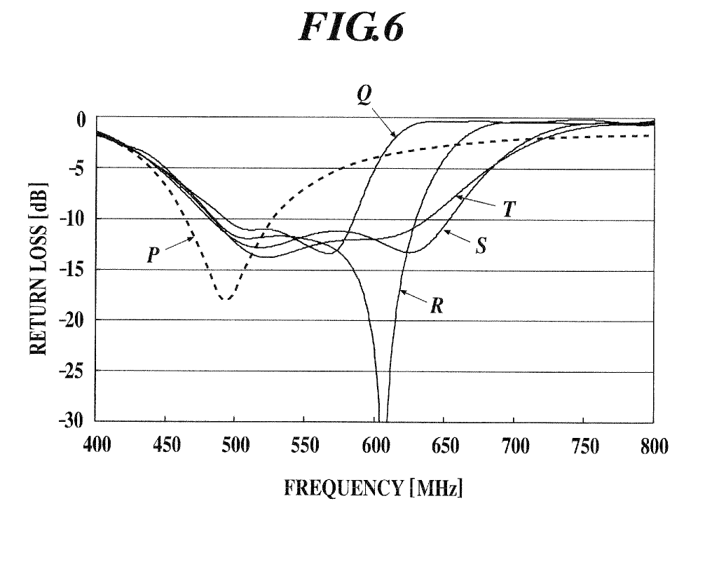

FIG. 6 shows an experimental result. As shown in the graph of FIG. 6, first, when the number of elements 32 of the parasitic device 3 of the antenna apparatus 1 is one (one pair of the sub-elements 33) (see solid line Q of the graph), compared to when only an antenna device 2, namely, a dipole antenna is provided and the parasitic device 3 is not provided (see broken line P of the graph), the frequency band where the return loss is adequately small and a radio wave can be effectively sent and received spreads to a high frequency side.

In other words, compared to when only the antenna device 2 is provided, in the antenna apparatus 1 of the present embodiment including a parasitic device 3, the sending and receiving sensitivity of the antenna apparatus 1 can be broadened.

Also, as shown in the graph of FIG. 6, when the number of elements 32 of the parasitic device 3 of the antenna apparatus 1 is increased to two (two pairs of sub-elements 33, see solid line R of graph) and four (four pairs of sub-elements 33, see solid line S of graph), the frequency band where the return loss is adequately small and a radio wave can be effectively sent and received spreads to an even higher frequency side, and the sending and receiving sensitivity of the antenna apparatus 1 can be an even broader band.

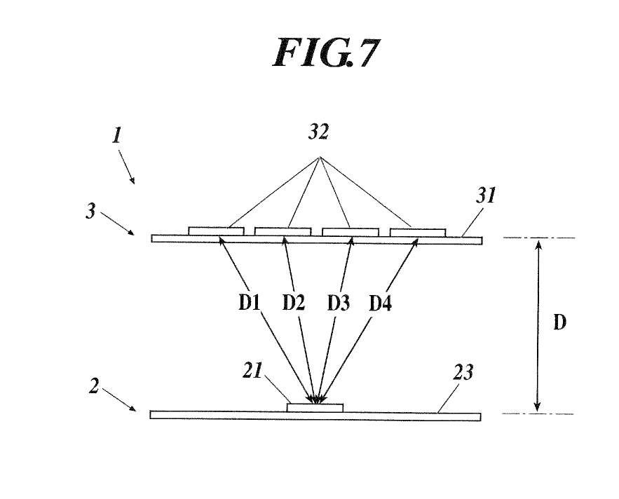

It is not clear why increasing the number of elements 32 (number of pairs of sub-elements 33) of the parasitic device 3 of the antenna apparatus 1 causes the frequency band where the return loss is adequately small and a radio wave can be effectively sent and received spreads to a high frequency side and causes the sending and receiving sensitivity of the antenna apparatus 1 to be an even broader band as described above. It is considered this is because for example, as shown in FIG. 7 showing the antenna apparatus 1 shown in FIG. 1 shown from the side, even when the antenna device 2 and the parasitic device 3 are formed to be separated at a distance D, the actual distance between the antenna element 21 of the antenna device 2 and each of the elements 32 of the parasitic device 3 is different such as D1 to D4, and the actual distance Dl to D4 are not all the same distance. In the present embodiment, D1=D4 and D2=D3.

As shown in FIG. 6, when the number of elements 32 of the parasitic device 3 of the antenna apparatus 1 is six (six pairs of sub-elements 33, see solid line T of graph), it is difficult to say that compared to when the number of elements 32 is four (see solid line S), the frequency band where the return loss is adequately small and a radio wave can be effectively sent and received spreads to a high frequency side and it can be seen that the broadening of the sending and receiving sensitivity of the antenna apparatus 1 becomes blunt.

Although it could be seen in the present embodiment that the broadening of the sending and receiving sensitivity of the antenna apparatus 1 becomes blunt when the number of elements 32 of the parasitic device 3 of the antenna apparatus 1 is six as described above, this is only a result of the above-described experimental condition. Putting it the other way around, the number of elements 32 (number of pairs of sub-elements 33) of the parasitic device 3 and the width W, interval I, etc. of the element 32 can be suitably determined so that the sending and receiving sensitivity is broadened to cover the necessary frequency band and the sending and receiving sensitivity is further enhanced while considering the broadening of the sending and receiving sensitivity may become blunt.

As described above, according to the antenna apparatus 1 of the present embodiment, the parasitic device 3 including one or a plurality of elements 32 is provided parallel to each of the antenna elements 21 of the antenna device 2 and at a position separated from each of the antenna elements 21, and also the parasitic device 3 is composed with a gap 34 provided at the center of each of the elements 32 in the extending direction and the pair of sub-elements 33 is composed to be symmetrical with respect to the gap 34 as a boundary. Consequently, an image electric current IC in the same direction as the electric current C generated in the antenna device 2 can be generated in the pair of sub-elements 33 of each of the elements 32 of the parasitic device 3.

Therefore, although the distance D between the antenna device 2 and the parasitic device 3 can only be as close as up to a quarter wavelength in the Yagi-Uda antenna-type antenna apparatus 100, as for the antenna apparatus 1 of the present embodiment, even if the distance D is closer, at least as for the front face of the apparatus, almost the same sending and receiving sensitivity as the Yagi-Uda antenna-type antenna apparatus 100 can be obtained as shown in FIG. 4, and the apparatus can be made smaller and thinner.

Also, by increasing the number of elements 32 (number of pairs of sub-elements 33) of the parasitic device 3, the frequency band where the return loss is adequately small and a radio wave can be effectively sent and received spreads to a high frequency side and the band of the sending and receiving sensitivity of the antenna apparatus 1 can be broadened. In this case, even if the number of elements 32 (number of pairs of sub-elements 33) increases, the width of the parasitic device 3 itself does not become so large as shown in FIG. 1 to FIG. 3.

Therefore, unlike in the antenna apparatus described above in the Patent Document 1 where the structure of a dipole antenna is applied, the apparatus becoming larger can be prevented, and the apparatus can be smaller and thinner while broadening the band of the sending and receiving sensitivity of the antenna apparatus 1.

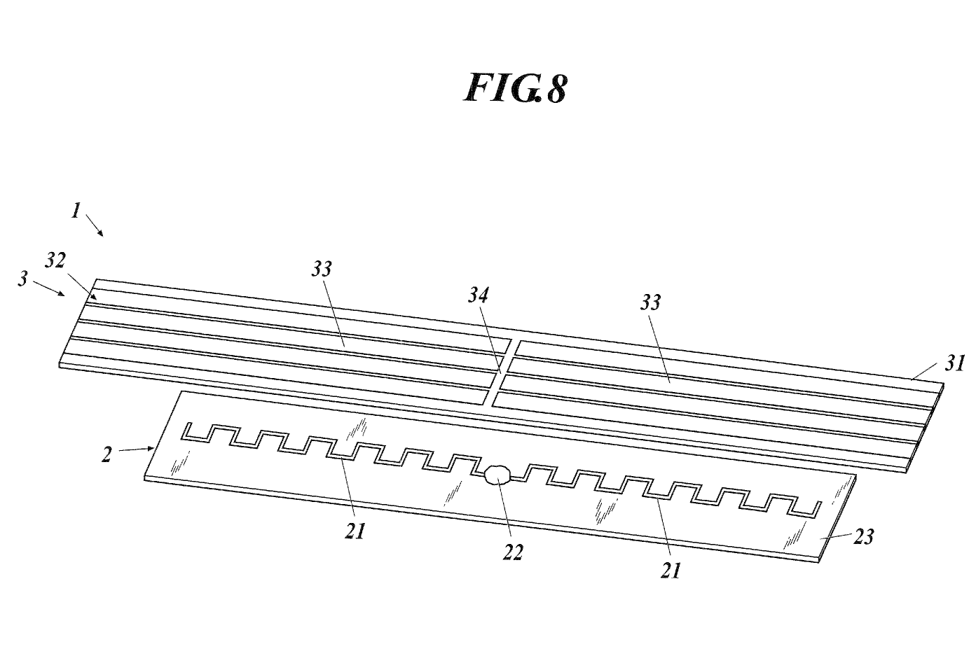

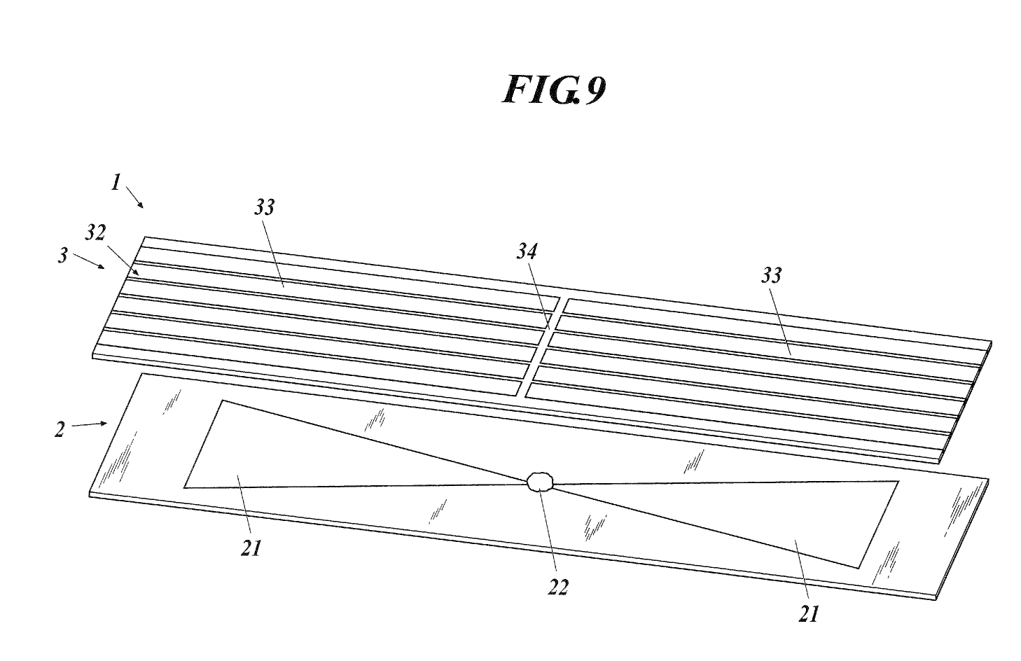

In the above embodiment, an example where the antenna device 2 is composed of a dipole antenna is described. However, other than this, the antenna device 2 can be composed of a meander antenna as shown in FIG. 8 or a bow-tie antenna as shown in FIG. 9.

Here, a meander antenna is an antenna where each of the antenna elements 21 and 21 placed symmetrically with respect to the feeding point 22 of the antenna device 2 are formed in a meander shape. The total length when each of the antenna elements 21 formed in the meander shape is extended hypothetically in a straight line determines a peak wavelength of the sending and receiving sensitivity of the meander antenna. FIG. 8 shows a meander antenna where each of the antenna elements 21 and 21 formed in the meander shape are placed symmetrically in a mirror image with respect to the feeding point 22 as a boundary, and alternatively, the antenna can be composed so that each of the antenna elements 21 and 21 are placed so as to be symmetrical with respect to the feeding point 22 as a point.

A bow-tie antenna is a double fan shaped antenna where a point of each of the antenna elements 21 and 21 formed in a triangular shape is connected to the feeding point 22 and each of the antenna elements 21 and 21 is placed symmetrically with respect to the feeding point 22. The bow-tie antenna has a characteristic that by forming each of the antenna elements 21 and 21 in a triangular shape, the band of the sending and receiving sensitivity broadens than a similar dipole antenna.

In these cases, each of the antenna elements 21 of the antenna device 2 being parallel to each of the elements 32 (each of the sub-elements 33) of the parasitic device 3 means when the antenna device 2 is the meander antenna, the extending direction of each of the antenna elements 21 extending in a direction away from the feeding point 22 and the extending direction of each of the elements 32 of the parasitic device 3 are parallel, and when the antenna device 2 is a bow-tie antenna, each center line including the feeding point 22 of each of the antenna elements with a triangular shape and the extending direction of each of the elements 32 of the parasitic device 3 are parallel.

As described above, the antenna device 2 composed of the meander antenna or bow-tie antenna can obtain an effect similar to those obtained by the above described embodiment where the antenna device 2 is composed of a dipole antenna.

Also, when the antenna device 2 is composed of a meander antenna, in addition to the above described effect, the antenna device 2 can be formed shorter in the extending direction of each of the antenna elements 21 compared to when the antenna device 2 is composed of the dipole antenna having the same peak wavelength of the sending and receiving sensitivity. Therefore, the antenna apparatus 1 can be made smaller.

Further, when the antenna device 2 is composed of a bow-tie antenna, in addition to the above described effect, the band of the sending and receiving sensitivity can be made broader than when the antenna device 2 is composed of the dipole antenna, and by providing the parasitic device 3, the band is broadened even more. Therefore, the band of the radio wave which can be sent and received by the antenna apparatus 1 can be broadened even more.

According to an aspect of the preferred embodiments of the present invention there is provided an antenna apparatus, comprising:

an antenna device including a feeding point and a pair of antenna elements placed symmetrically with respect to the feeding point; and

a parasitic device placed parallel to each of the antenna elements of the antenna device and including one or a plurality of elements placed at a position separated from each of the antenna elements, wherein

the element of the parasitic device includes a gap at a center of the element in an extending direction and includes a pair of sub-elements structured symmetrically with respect to the gap as a boundary.

According to the aspect, the parasitic device including one or a plurality of elements is provided parallel to each of the antenna elements of the antenna device and at a position separated from each of the antenna elements, and also the parasitic device is composed with a gap provided at the center of each of the elements in the extending direction and the pair of sub-elements is composed to be symmetrical with respect to the gap as a boundary. Consequently, an image electric current in the same direction as the electric current generated in the antenna device can be generated in the pair of sub-elements of each of the elements of the parasitic device.

Therefore, although the distance between the antenna device and the parasitic device can only be as close as up to a quarter wavelength in the Yagi-Uda antenna-type antenna apparatus 100 shown in FIG. 10, even if the antenna device and the parasitic device is closer in the present embodiment, at least as for the front face of the apparatus, almost the same sending and receiving sensitivity as the Yagi-Uda antenna-type antenna apparatus 100 can be obtained, and the apparatus can be made smaller and thinner.

Also, by increasing the number of elements (number of pairs of sub-elements) of the parasitic device, the frequency band where a radio wave can be effectively sent and received spreads to a high frequency and the band of the sending and receiving sensitivity of the antenna apparatus can be broadened. In this case, even if the number of elements (number of pairs of sub-elements) increases, as shown in FIG. 1 to FIG. 3, the width of the parasitic device itself does not become so large. Therefore, unlike when the structure of the antenna apparatus described in the Patent Document 1 is applied to the antenna device, the apparatus becoming larger can be prevented, and the apparatus can be smaller and thinner while broadening the band of the sending and receiving sensitivity of the antenna apparatus 1.

Preferably, in the antenna apparatus, the gap of the element of the parasitic device is provided in a direction orthogonal to an extending direction of the antenna element, the direction passing through the feeding point.

According to the aspect, in addition to the above described effect, by providing the gap between the elements of the parasitic device in a direction orthogonal to the extending direction of the antenna element from the feeding point of the antenna device, the directional characteristic of the radio wave sent and received by the antenna apparatus can be directed in a direction of the front face of the apparatus, in other words, in the direction from the antenna device towards the parasitic device.

Preferably, in the antenna apparatus, the parasitic device comprises one element including the pair of sub-elements.

According to the aspect, when the parasitic device is structured to include an element including a pair of sub-elements, an image electric current can be generated in the pair of sub-elements of the element of the parasitic device in the same direction as the electric current generated in the antenna device, therefore, the distance between the antenna device and the parasitic device can be closer and the apparatus can be made smaller and thinner. Also, the band of the sending and receiving sensitivity of the antenna apparatus can be broader than that of the Yagi-Uda antenna-type antenna apparatus, and therefore, the above described effect of the present embodiment can be effectively achieved.

Preferably, in the antenna apparatus, the parasitic device comprises a plurality of the elements each including the pair of sub-elements and aligned parallel to each other with a predetermined interval in a direction orthogonal to the extending direction of the element.

According to the aspect, by aligning a plurality of elements each including a pair of sub-elements in the parasitic device parallel to each other, an image electric current can be generated in the pair of sub-elements of each of the elements of the parasitic device in the same direction as the electric current generated in the antenna device, therefore, the distance between the antenna device and the parasitic device can be closer and the apparatus can be made smaller and thinner. Thus, the above described effect of the present embodiment can be effectively achieved and also the frequency band where a radio wave can be effectively sent and received further spreads to a high frequency, and therefore the band of the sending and receiving sensitivity of the antenna apparatus can be broadened.

Preferably, in the antenna apparatus, lengths of the plurality of elements in a direction orthogonal to the extending direction are same as one another, lengths of the sub-elements in the extending direction are same as one another, widths of the intervals are same as one another and the intervals between elements are same as one another.

According to the aspect, the above described effect of the present embodiment can be effectively achieved, and also by making the shape of the plurality of elements the same, the structure of the parasitic device can be simplified, and the parasitic device can be formed easily, accurately and reliably.

Preferably, in the antenna apparatus, the antenna device is composed of a dipole antenna.

Preferably, in the antenna apparatus, the antenna device is composed of a meander antenna.

Preferably, in the antenna apparatus, the antenna device is composed of a bow-tie antenna.

According to these aspects, even when the antenna device is composed of any of the dipole antenna, the meander antenna or the bow-tie antenna, the above described effect of the present embodiment can be effectively achieved. Also, when the antenna element is composed of the dipole antenna, the antenna element does not need a special structure, and therefore, the antenna apparatus can be manufactured at a low cost. When the antenna element is composed of a meander antenna, the antenna element and the antenna apparatus can be made smaller. When the antenna element is composed of the bow-tie antenna, the band of the radio wave which can be sent and received by the antenna apparatus can be further broadened.

The entire disclosure of Japanese Patent Application No. 2008-036210 filed on Feb. 18, 2008 including description, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An antenna apparatus, comprising:
an antenna device including a feeding point and a pair of antenna elements placed symmetrically with respect to the feeding point; and
a parasitic device placed parallel to each of the antenna elements of the antenna device and including one or a plurality of elements placed at a position separated from each of the antenna elements, wherein
the element of the parasitic device includes a gap at a center of the element in an extending direction and includes a pair of sub-elements structured symmetrically with respect to the gap as a boundary.

2. The antenna apparatus according to claim 1, wherein the gap of the element of the parasitic device is provided in a direction orthogonal to an extending direction of the antenna element, the direction passing through the feeding point.

3. The antenna apparatus according to claim 1, wherein the parasitic device comprises one element including the pair of sub-elements.

4. The antenna apparatus according to claim 1, wherein the parasitic device comprises a plurality of the elements each including the pair of sub-elements and aligned parallel to each other with a predetermined interval in a direction orthogonal to the extending direction of the element.

5. The antenna apparatus according to claim 4, wherein lengths of the plurality of elements in a direction orthogonal to the extending direction are same as one another, lengths of the sub-elements in the extending direction are same as one another, widths of the intervals are same as one another and the intervals between elements are same as one another.

6. The antenna apparatus according to claim 1, wherein the antenna device is composed of a dipole antenna.

7. The antenna apparatus according to claim 1, wherein the antenna device is composed of a meander antenna.

8. The antenna apparatus according to claim 1, wherein the antenna device is composed of a bow-tie antenna.
